(19) United States
(12) Patent Application Publication
(10) Pub. No.: US 2003/0180513 A1
(43) Pub. Date: Sep. 25, 2003

(54) Foam part and method for producing the same

(76) Inventor: Horst Steinmeier, Lubbecke (DE)

Correspondence Address: FOLEY & LARDNER, 777 EAST WISCONSIN AVENUE, SUITE 3800, MILWAUKEE, WI, 53202-5308, US

(21) Appl. No.: 10/240,634

(22) PCT Filed: Mar. 23, 2001
(86) PCT No.: PCT/EP01/03303

(30) Foreign Application Priority Data
Apr. 3, 2000 (DE) 100 16 350.5

(51) Int. Cl. B32B 7/02

(52) U.S. Cl. 428/217; 428/212

(57) ABSTRACT

The invention relates to a foam part consisting of polyurethane or similar, especially for use as a support for backrests, seats or similar of vehicle seats. Said foam part has a first area (2) consisting of foam with a first composition and a second area (3) consisting of foam with a second composition. The inventive foam part is produced economically by providing a network (4) of polyethylene, jute, gauze, nonwoven material or similar between the first and second areas (2, 3).

The invention refers to a foam part of polyurethane, etc., especially for use as a support for backrests, seat surfaces, etc. or vehicle seats with a first area consisting of foam with a first composition, and a second area consisting of foam with a second composition, and a method to manufacture the foam part.

Backrests, seats surfaces, etc. of vehicle seats are increasingly being made of foam parts made of polyurethane (PUR) with covers made of fabric, leather, etc. To manufacture the foam parts, liquid polyurethane is injected into a mold that is subsequently sealed and heated so that the polyurethane foams, and the foam part assumes the desired shape. To ensure extra sitting comfort, it is also prior art to subdivide the foam part into zones with different properties, especially degrees of hardness. For example, a hard foam area can be provided under soft foam that provides comfortable sitting to increase the stability of the seat cushion shape. Such a horizontally divided two-zone foam part is relatively difficult to manufacture and is therefore expensive. Normally, a soft foam is first injected into a mold and foamed, and after the foam part passes through the foam device, it is put back into the mold, and then the hard foam material is injected over it and then foamed. This creates a uniform connection between the hard and soft foam, however this procedure requires a few hours. It is also not possible to precisely separate the hard and soft foam zones. It is also prior art to manufacture the hard and soft foam areas separately and then glue them. However this additional step increases cost substantially, and a large number of pieces must be used, especially to manufacture automobile seats.

The problem of the invention is therefore to achieve savings in manufacturing a two-zone foam part.

This problem is essentially solved according to the invention by placing a network consisting of polyethylene, jute, gauze, nonwoven material, etc. between the first (soft foam) and second (hard foam) areas of the foam part. This network in the dividing plane between the first and second areas of foam part allows the foam part to be quickly and economically manufactured with precisely separated zones.

The dividing plane formed by the network preferably lies in a horizontal plane of the foam part.

In a preferred embodiment of the invention, the network is designed as a pocket into which the second area is foamed. The pocket allows the hard foam area to assume a special contour inside the foam part.

According to a first embodiment, the pocket basically has a wedge shaped when open, and in a second embodiment, it is essentially rectangular.

Seat cushions are normally designed with a middle area that essentially serves as a seat surface, and a side area that is placed over the side edges of the usually metallic seat frame. According to an embodiment of the invention, the soft and hard foam are only separated in the middle while the side area consists completely of soft foam. This makes it easier to design the manufactured shape since the network only has to lie in the middle area. It is, however, also possible in another embodiment to separate the hard and the soft foam both in the middle area and in the side area.

The invention also concerns a method to manufacture the above-described foam part. Initially, foam with a first composition, especially soft foam, is introduced into a mold and foamed, and then a network is placed (especially stretched) over the foam, and then a foam material with a second composition, especially hard foam, is introduced into the mold over the network and foamed.

If the network is designed as a pocket, the corners of the pocket facing the top the mold are fixed to the cover of the mold, and the foam material with the second composition is introduced into the pocket and foamed.

The invention will be further explained in the following with reference to exemplary embodiments and the drawing.

Shown are:

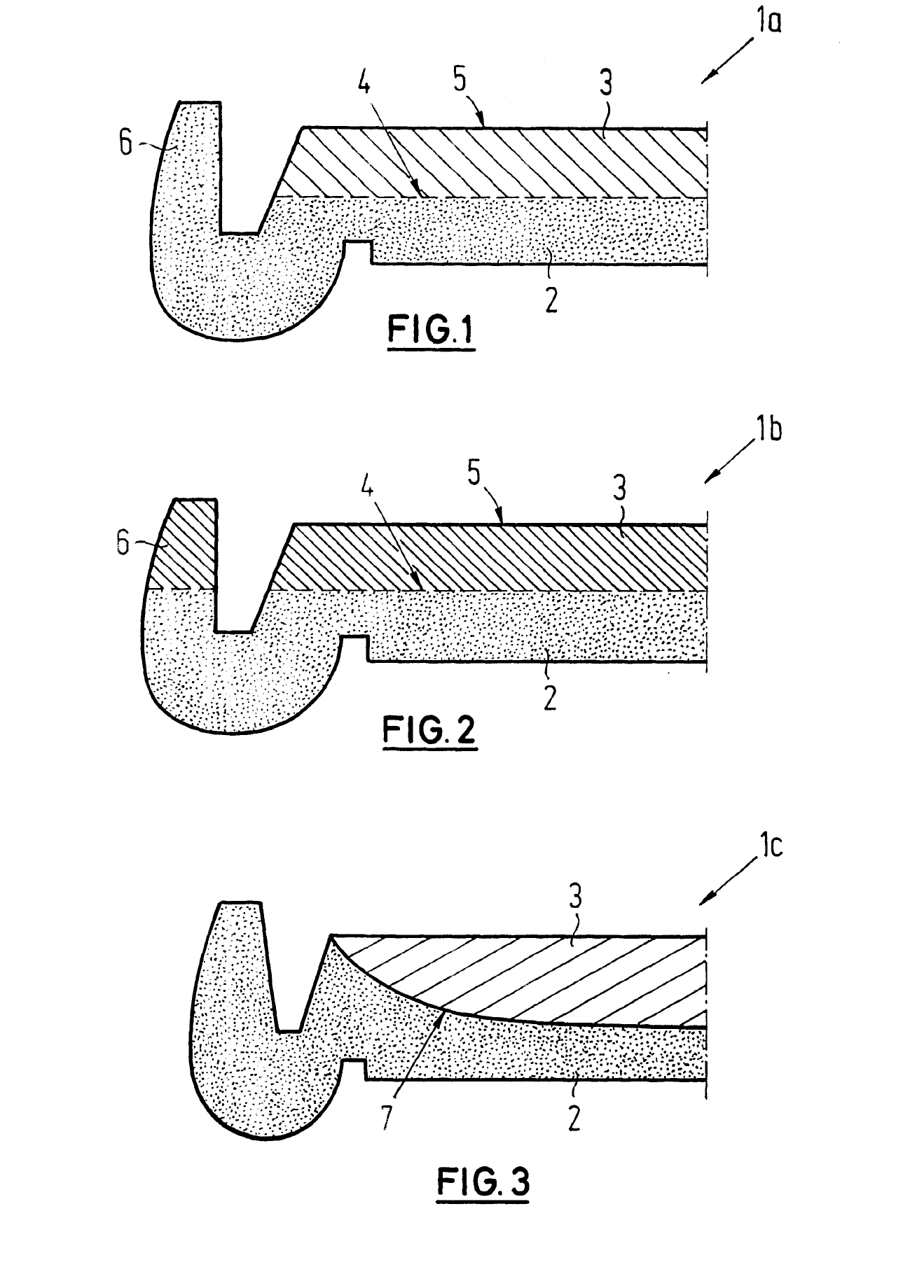

FIG. 1 Schematic part section of a foam part according to a first embodiment of the invention,

FIG. 2 Schematic part section of a foam part according to a second embodiment of the invention,

FIG. 3 Schematic part section of a foam part according to a third embodiment of the invention,

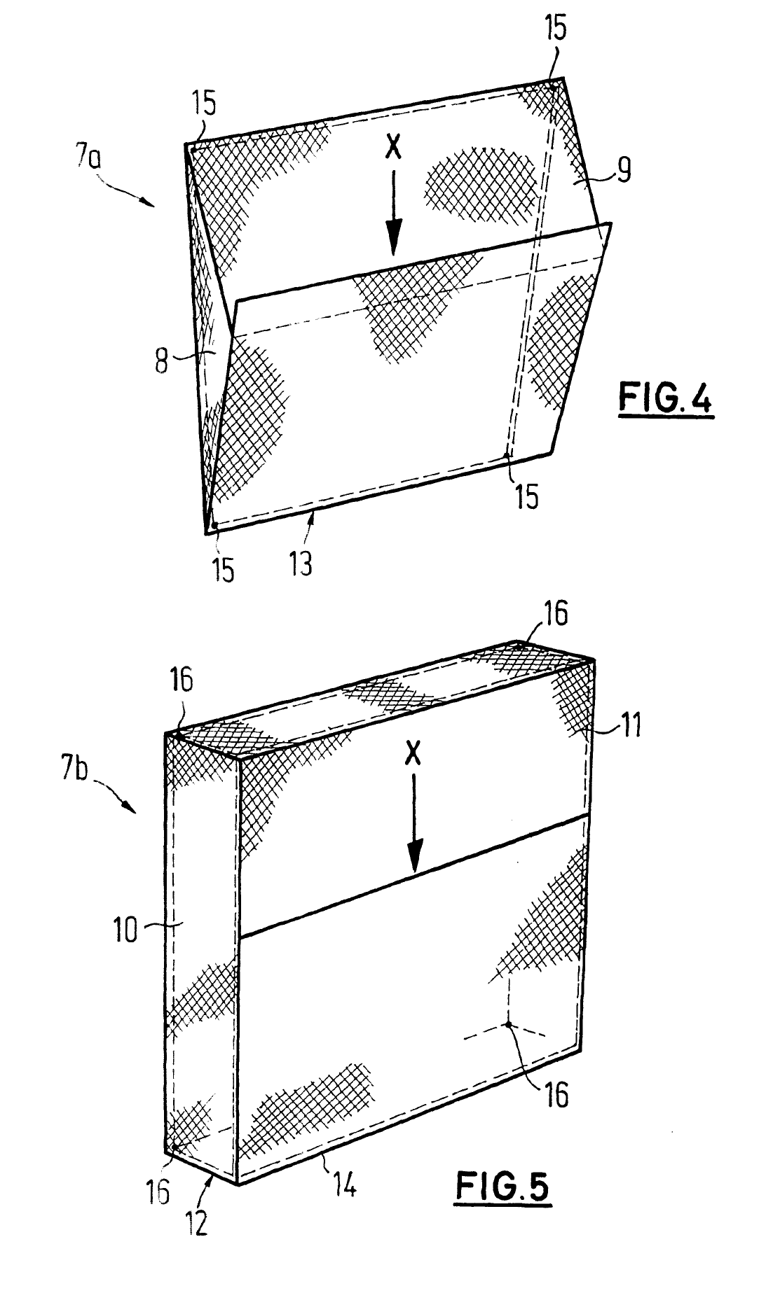

FIG. 4 Schematic pocket that serves to receive the hard foam, and

FIG. 5 Another embodiment of a pocket to receive the hard foam.

The foam part 1 consisting of polyurethane (PUR) etc. shown in FIG. 1 to 3 has a first area 2 consisting of soft foam and a second area 3 on top of it consisting of hard foam. The properties of the first and second areas 2, 3 are normally established by adding a different amount of isocyanate to the polyurethane. The more isocyanate, the harder the foam. Instead of isocyanate, any other suitable additive that influences the hardness can of course be added to the polyurethane. Note that the alignment of the foam part shown in the drawings corresponds to the normal manner of manufacturing the foam part 1 in which the soft foam area is first formed followed by the hard foam area. When placed on vehicle seats, the foam part 1 is turned around so that the hard foam area 3 faces the usually metallic seat frame. The driver or passenger accordingly sits on the soft, comfortable soft foam area 2.

Between the first area (soft foam) 2 and the second area (hard foam) 3, there is a network or fabric 4 consisting of polyethylene, jute, gauze, nonwoven material, etc. to separate the areas from each other. The network is porous to allow gases to pass through when foaming and to allow the two foam areas to bond that, when foaming, slightly pass through the holes in the network to the other side.

In the embodiment in FIG. 1, foam part 1a is only divided by the network 4 into two areas 2, 3 in its middle area 5 that normally serves as a seat surface, whereas a side area 6 that stretches over the side edges of the seat frame consists of soft foam.

In the foam part lb in FIG. 2, the separation between the first area 2 and the third area 3 is provided by the network 4 both in the middle area 5 and in the side area 6.

The network 4 can either be designed as a simple network that is stretched over the first area 2, or as a pocket 7 as shown in FIGS. 4 and 5. With the first embodiment of a pocket 7a shown in FIG. 4, the pocket has triangular sidewalls 8, 9 so that the pocket 7a is designed as a wedge when open.

The pocket 7b in FIG. 5 according to the second embodiment is essentially rectangular with rectangular sidewalls 10, 11 and a floor 12. The seams 13 of the pocket 7a, b are sewn or welded depending on the selected network material.

The foam part according to the invention is manufactured by first injecting a soft foam material into a foam mold and foaming it under heat. Directly after foaming, the mold can be opened, and the network 4 possibly designed as a pocket 7a, b is stretched over the soft foam 2. A separate stretching frame can be used so that a three-part mold results consisting of a bottom part, stretching frame and mold cover. When a pocket 7a, b is used, the corners 15, 16 of the pocket 7a, b facing the top of the mold are fixed to the cover of the mold, and the hard foam material is injected into the pocket 7a, b and foamed under heat. This is illustrated in FIGS. 4 and 5 by the arrow X. A special stretching frame can be eliminated in this instance. When foaming the hard foam in a pocket 7a, b, the pocket 7a, b expands in the middle to produce the bulge ofthe hard foam area 3 shown in FIG. 3 desired contour for the hard foam area and hence also for the soft foam area by means of which the sitting properties can be influenced.

The foam part 1 can be removed from the mold after approximately 4 minutes, and it has a gelatin-like consistency. After approximately 72 hours, the foam part 1 has completely cured.

While foaming, the foam meshes with the network 4 to produce a reliable bond between the first second areas 2, 3 without requiring additional gluing.

By means of the invention, the horizontal two-zone foam is economically manufactured without increasing the processing time of the foaming process, and the zones are precisely separated between the hard and soft areas.

### LIST OF REFERENCE NUMBERS

1 Foam part

2 First area

3 Second area

4 Network

5 Middle area

6 Side area

7a, b Pocket

8 Side wall

9 Side wall

10 Side wall

11 Side wall

12 Floor

13 Seam

14 Seam

15 Corner

16 Corner

1. Foam part consisting of polyurethane etc., especially for use as a support for backrests, seat surfaces etc. for vehicle seats, with a first area (2) consisting of foam with a first composition, and a second area (3) consisting of foam with a second composition, characterized in that a network (4) is provided between the first and second areas (2, 3) that is made of polyethylene, jute, gauze, nonwoven material, etc.

2. Foam part according to claim 1, characterized in that the dividing plane formed by the network (4) lies in a horizontal plane of the foam part (1).

3. Foam part according to claim 1 or 2, characterized in that the network (4) is designed as a pocket (7a, b) in which the second area (3) is foamed.

4. Foam part according to claim 3, characterized in that the pocket (7a) is essentially wedge-shaped when open.

5. Foam part according to claim 3, characterized in that the pocket (7b) is essentially rectangular.

6. Foam part according to one of the prior claims, characterized in that the first area (2) is a soft foam, and the second area (3) is a hard foam.

7. Foam part according to one of the prior claims with a middle area (5) that essentially serves as a seat surface, and a side area (6) to be affixed to the vehicle seats, characterized in that the hard and soft foams are only separated in the middle area (5), and the side area (6) consists of soft foam.

8. Foam part according to one of claims 1 to 6 with a middle area (5) that essentially serves as a seat surface, and a side area (6) affixed to the vehicle seats, characterized in that the soft and hard foams are separated in both the middle area (5) as well as in the side area (6).

9. Method to manufacture a foam part according to one of the prior claims in which a foam with a first composition, especially a soft foam, is introduced into a mold and foamed, and a network is placed over the foam (especially stretched), and a foam material with a second composition, especially a hard foam, is introduced into the mold over the network and foamed.

10. Method according to claim 9, characterized in that the network is designed as a pocket, the corners of the pocket facing the top of the mold are affixed to the cover of the mold, and the foam material with the second composition is introduced into the pocket and foamed there.
